(19) United States
(12) Patent Application Publication
(10) Pub. No.: US 2002/0197531 A1
(43) Pub. Date: Dec. 26, 2002

(54) Negative electrode active material and nonaqueous electrolyte battery

(76) Inventors: Hiroshi Inoue, Kanagawa (JP); Shinichiro Yamada, Kanagawa (JP); Takuya Endo, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/053,467

(22) Filed: Nov. 7, 2001

(30) Foreign Application Priority Data
Nov. 7, 2000 (JP) P2000-339546

(51) Int. Cl. H01M 4/58; C01B 33/06; H01M 4/38; C22C 38/60; C22C 38/00; C22C 9/08; C22C 9/00; C01B 33/00

(52) U.S. Cl. 429/220; 429/221; 429/225; 429/231.4; 423/324; 252/182.1; 420/84; 420/8; 420/491; 420/499; 420/469

(57) ABSTRACT

A negative electrode active material includes a composition A-B-C containing a first element A which is at least one selected from copper and iron, a second element B which is at least one selected from silicon and tin, and a third element C which is at least one selected from the group consisting of indium, antimony, bismuth, and lead. A nonaqueous electrolyte battery includes a negative electrode containing the negative electrode active material, a positive electrode containing a positive electrode active material, and a nonaqueous electrolyte. The nonaqueous electrolyte battery has a large discharge capacity and excellent cycle performance.

### BACKGROUND OF THE INVENTION

1. Field of the Invention

The present invention relates to a negative electrode active material which is capable of being doped and undoped with lithium, and to a nonaqueous electrolyte battery including the negative electrode active material.

2. Description of the Related Art

Compact portable electronic devices such as video tape recorders with video cameras, mobile phones, and laptop computers have been developed, as electronic technology has advanced. As a result, developing a secondary battery which is compact and light and has a high energy density is required for the portable power source of the electronic devices.

For the secondary battery which satisfies the above requirements, developing a new nonaqueous electrolyte battery having a negative electrode active material containing a light metal such as lithium, sodium, and aluminum which theoretically generate a high voltage and a have high energy density is expected. The nonaqueous electrolyte battery, particularly a lithium secondary battery, has been actively investigated because the lithium secondary battery is easy to handle, generates a high voltage, and has a high energy density.

When the light metal such as lithium is directly used for the negative electrode active material of the nonaqueous secondary battery, the light metal is deposited on a negative electrode to form a dendrite and current density excessively increases at the top of the dendrite during electrical charging. In the above use, there is a problem in that the cycle life of the nonaqueous secondary battery is decreased by electrolysis of a nonaqueous electrolyte solution and an internal short-circuit is caused by the excessive growth of the dendrite, wherein the cycle life is the number of times that a rechargeable battery can be charged and discharged.

In order to prevent the deposition of the dendrite, the negative electrode includes a graphite intercalated with lithium ions or a carbonaceous material doped with lithium ions into the pores thereof instead of directly using a lithium ion.

Since composition of a first-stage graphite intercalation compound is C-6Li, there is an upper limit of the capacity of the negative electrode containing the intercalated graphite. Also, in the carbonaceous material which is doped and undoped, controlling the porous structure thereof to increase a doping and undoping capacity is difficult on a commercial scale.

In light of the above, it is difficult for current carbonaceous materials to meet the long use of the electronic devices and the high energy density of a power source. Thus, developing a new negative electrode active material which has a large lithium-doping and undoping capacity is required.

### SUMMARY OF THE INVENTION

Accordingly, it is an object of the present invention to provide a negative electrode active material which has a large lithium-doping and undoping capacity, and to provide a nonaqueous electrolyte battery which includes the negative electrode active material and has an excellent performance.

The negative electrode active material of the present invention includes a composition A-B-C containing a first element A, a second element B, and a third element C, wherein the first element A is at least one selected from copper and iron; the second element B is at least one selected from silicon and tin; and the third element C is at least one selected from the group consisting of indium, antimony, bismuth, and lead.

In the negative electrode active material including such a composition, each element functions as follows: the first element A is not alloyed with lithium, and thus the structural stability of the composition is maintained; the second element B is alloyed with lithium, and thus a large discharge capacity is achieved; and the third element C causes distortion of the crystal structure of the composition, and thus lithium ions move smoothly and the charge and discharge efficiency and the cycle life are improved.

The nonaqueous electrolyte battery of the present invention includes a negative electrode containing the negative electrode active material described above, a positive electrode containing a positive electrode active material, and a nonaqueous electrolyte.

The nonaqueous electrolyte battery has a greatly increased energy density per volume, a large discharge capacity, and an excellent cycle performance.

### BRIEF DESCRIPTION OF THE DRAWINGS

FIG. 1 is a sectional view showing an example of a coin-shaped battery of the present invention; and

FIG. 2 is a diagram showing an X-ray diffraction pattern of Sample 0 and Sample P of the present invention.

### DESCRIPTION OF THE PREFERRED EMBODIMENT

The preferred embodiment of the present invention will be described in detail below.

The negative electrode active material of the present invention is a composition containing a first element A, a second element B, and a third element C. The composition is represented by a general formula xA-yB-zC, wherein the first element A is at least one selected from copper and iron; the second element B is at least one selected from silicon and tin; and the third element C is at least one selected from the group consisting of indium, antimony, bismuth, and lead. Also, x, y, and z represent the content % by weight of the first element A, the second element B, and third element C, respectively.

In the negative electrode active material containing such a composition, each element functions as follows: copper and iron of the first element A are not alloyed with lithium, and thus the structural stability of the composition is maintained; silicon and tin of the second element B are alloyed with lithium, and thus a large discharge capacity is achieved; and indium, antimony, bismuth, and lead of the third element C cause distortion of the crystal structure of the composition, and thus the lithium ions move smoothly and the charge and discharge efficiency and the cycle life are improved. Accordingly, the negative electrode active material has a large lithium-doping and undoping capacity compared with conventional carbonaceous materials. Furthermore, the cycle performance of the negative electrode active material is highly improved compared with conventional negative electrode active materials composed of silicon or tin.

The second element content y is preferably 5 to 50% by weight and more preferably 10 to 40% by weight. The third element content z is preferably 1 to 50% by weight and more preferably 5 to 40% by weight.

When the second element content y is less than 5% by weight, large discharge capacity is not achieved. When the second element content y is more than 50% by weight, the structural stability of the composition is not maintained and excellent cycle performance is not achieved because the first element content x and the third element content z are less than a lower limit. Accordingly, when the second element content y is 5 to 50% by weight, large discharge capacity is achieved without impairing the structural stability and the cycle performance.

When the third element content z is less than 1% by weight, excellent cycle performance is not achieved. When the third element content z is more than 50% by weight, the structural stability is not maintained and large discharge capacity is not achieved because the first element content x and the second element content y are less than a lower limit. Accordingly, when the third element content z is 1 to 50% by weight, excellent cycle performance is achieved without impairing the structural stability and the large discharge capacity.

The total amount of the second element content y and the third element content z, namely, y+z is preferably 80% by weight or less, more preferably 70% by weight or less, and further more preferably 50% by weight or less.

When the y+z exceeds 80% by weight, the structural stability is not maintained because the first element content x is less than a lower limit. If the structural stability is not maintained, large discharge capacity and excellent cycle performance are not achieved by increasing the contents of the second element B and the third element C. Accordingly, when the y+z is 80% by weight or less, the structural stability is maintained, and large discharge capacity and excellent cycle performance is achieved.

The composition may be, for example, 45Fe-35Si-20In or 70Cu-15Si-10In-5Sb.

The composition of the negative electrode active material may be a crystalline intermetallic, or preferably a low crystalline intermetallic. The composition is more preferably an amorphous intermetallic. If the composition is not amorphous, another element having an atomic diameter which is different from those of the elements contained in the composition may be added to the composition in order to degrade the crystallinity of the composition. Such an element may be a light element such as boron, carbon, or nitrogen, or a rare earth element. Materials containing such an element may also be used for the negative electrode active material.

The low crystalline or amorphous material is defined as a material having a half width of 0.5 degrees (2θ) or more and a broad peak between 30 and 60 degrees (2θ) in an X-ray diffraction pattern. The amorphous composition provides a high electric potential at a discharge mode.

A method for preparing the composition is not limited and known technologies are applicable to the method. For example, the composition may be prepared by melting a raw material mixture in a furnace, for example, an electric furnace, a high-frequency induction heater, or an arc-smelting furnace and then solidifying the melt. The resulting composition must be quenched in order to make the composition amorphous. The quenching process may be gas-atomizing, water-atomizing, spraying, and twin-roll. Also, the composition may be produced by mechanical alloying or vacuum film deposition.

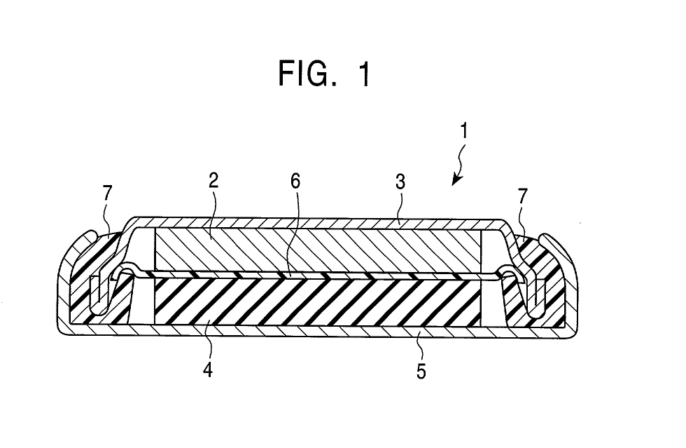

FIG. 1 shows an exemplary coin-shaped nonaqueous electrolyte battery of the present invention, in which the composition of the negative electrode active material is used. The nonaqueous electrolyte battery 1 includes a negative electrode 2, a negative electrode case 3 for housing the negative electrode 2, a positive electrode 4, a positive electrode case 5 for housing the positive electrode 4, a separator 6 placed between the positive electrode 4 and the negative electrode 2, and an insulating gasket 7, wherein the negative electrode case 3 and the positive electrode case 5 are filled with a nonaqueous electrolyte solution.

In the negative electrode 2, a layer of a negative electrode active material containing the above composition is formed on a negative electrode collector. The negative electrode collector may be a nickel foil or the like.

In the nonaqueous electrolyte battery 1, the composition of the negative electrode active material is represented by a general formula xA-yB-zC, wherein the first element A is at least one selected from copper and iron; the second element B is at least one selected from silicon and tin; and the third element C is at least one selected from the group consisting of indium, antimony, bismuth, and lead.

In the above composition, each element functions as follows: the copper or iron of the first element A is not alloyed with lithium, and thus the structural stability of the composition is maintained; the silicone or tin of the second element B is alloyed with lithium, and thus a large discharge capacity is achieved; and the indium, antimony, bismuth, or lead of the third element C causes distortion of the crystal structure of the composition, and thus lithium ions move smoothly and the charge and discharge efficiency and the cycle performance are improved. Accordingly, the negative electrode active material has the large doping and undoping capacity compared with conventional carbonaceous materials. Further, the negative electrode active material has the excellent cycle performance compared with conventional negative electrode active materials composed of silicon or tin.

The second element content y is preferably 5 to 50% by weight, and more preferably 10 to 40% by weight. The third element content z is preferably 1 to 50% by weight, and more preferably 5 to 40% by weight.

When the second element content y is 5 to 50% by weight, the large discharge capacity is achieved without impairing the structural stability. Also, when the third element content z is 1 to 50% by weight, the excellent cycle performance is achieved without impairing the structural stability and the large discharge capacity.

The total amount of the second element content y and the third element content z, namely, y+z is preferably 80% by weight or less, more preferably 70% by weight or less, and further more preferably 50% by weight or less. When the y+z is 80% by weight or less, the structural stability is maintained, and the large discharge capacity and the excellent cycle performance is achieved.

The nonaqueous electrolyte battery 1 including the negative electrode active material of the present invention has a high energy density per volume, a large negative electrode capacity, and excellent cycle performance compared with conventional batteries.

The negative electrode active material layer preferably contains a carbonaceous material which is capable of being doped and being undoped with lithium, in addition to the negative electrode active material. The carbonaceous material may be one selected from the group consisting of non-graphitizable carbon, graphitizable carbon, and graphite.

When the negative electrode includes the negative electrode active material, the negative electrode active material may contain a binder, a carbonaceous material, metal powder, and a conductive polymer in order to have electric conductivity thereof. The binder may be known polymers which are generally used for the negative electrode active material of the nonaqueous electrolyte battery.

The negative electrode case 3 houses the negative electrode 2 and functions as the external negative electrode of the nonaqueous electrolyte battery 1.

In the positive electrode 4, a layer of a positive electrode active material is formed on a positive electrode collector. The positive electrode collector may be an aluminum foil or the like.

When the nonaqueous electrolyte battery includes the above negative electrode active material, the positive electrode preferably contains a sufficient amount of lithium. For example, a lithiated metal oxide represented by a general formula LiₓMO₂ or LiₓM₂O₄, or an intercalation compound containing lithium is preferably used for the positive electrode, wherein M is at least one selected from the group consisting of cobalt, nickel, and manganese, and wherein x is 0<x<1.

The lithiated metal oxide may be prepared as follows: a lithium compound such as carbonate, nitrate, oxide, or hydroxide, and a cobalt, nickel, or manganese compound such as carbonate, nitrate, oxide, or hydroxide are pulverized, are mixed, and then are fired at 600 to 1,000° C. in an oxygen atmosphere.

The binder of the positive electrode active material layer may be known polymers which are generally used for positive electrode active materials of conventional nonaqueous electrolyte batteries.

Because an object of the nonaqueous electrolyte battery 1 of the present invention is to achieve a large discharge capacity, the above positive electrode is required to contain a sufficient amount of lithium at a steady state, for example, the state after fifth cycle of charge and discharge. The sufficient amount of lithium corresponds to a discharge capacity of at least 250 mAh/g of the negative electrode active material, preferably at least 300 mAh/g, and more preferably at least 350 mAh/g. The positive electrode active material may not necessarily supply the total amount of lithium, and the amount of lithium which is equivalent to an amount of a discharge capacity of at least 250 mAh/g of the negative electrode active material may be present in the battery. The amount of lithium is determined according to the measurement of the discharge capacity of the battery.

The positive electrode case 5 houses the positive electrode 4 and functions as the external positive electrode of the nonaqueous electrolyte battery 1.

The separator 6 separates the positive electrode 4 from the negative electrode 2, and may be composed of a conventional material, for example, a polymer film such as polypropylene, which is generally used for separators of conventional nonaqueous electrolyte batteries. The separator 6 is required to have a thin thickness according to the relationship between the ion conductivity of lithium and the energy density of the battery. A thickness of, for example, 50 μm or less is preferable for the separator 6.

The insulating gasket 7 is combined with the negative electrode case 3 to prevent a nonaqueous electrolyte solution from leaking, in which the negative electrode case 3 and the positive electrode case 5 are filled with the solution.

For example, the nonaqueous electrolyte solution contains an aprotic nonaqueous solvent and an electrolyte.

Examples of the solvents are propylene carbonate, ethylene carbonate, diethyl carbonate, ethyl methyl carbonate, 1,2-dimethoxyethane, 1,2-diethoxyethane, y-butyrolactone, tetrahydrofuran, 2-methyl tetrahydrofuran, 1,3-dioxolane, 2-methyl-1,3-dioxolane, diethyl ether, sulfolane, methyl sulfolane, acetonitrile, propylnitrile, anisole, acetic esters, propionic esters. These may be used alone or in combination.

Examples of electrolytes are lithium salts such as LiClO₄, LiAsF₆, LiPF₆, LiBF₄, LiB(C₆H₅)₄, LiCH₃SO₃, LiCF₃SO₃, LiCl, and LiBr.

The nonaqueous electrolyte battery of the present invention includes the negative electrode active material containing the composition represented by a general formula A-B-C, wherein the first element A is at least one selected from copper and iron; the second element B is at least one selected from silicon and tin; and the third element C is at least one selected from the group consisting of indium, antimony, bismuth, and lead. Thus, the nonaqueous electrolyte battery has a high energy density per volume, large negative electrode capacity, and excellent cycle performance compared with conventional batteries.

Although the nonaqueous electrolyte battery 1 including the nonaqueous electrolyte solution is described in the above embodiment, the present invention is not limited to the embodiment. The present invention is applicable to a solid electrolyte battery including a polymer solid electrolyte containing a single or composite conductive polymer, or a gel electrolyte battery including a gel electrolyte containing a swelling solvent.

Examples of the conductive polymers are a silicone polymer, an acrylic polymer, polyacrylonitrile, modified phosphazene polymers, polyethylene oxide, polypropylene oxide, a fluoric polymer, and a composite, crosslinked, or modified polymer thereof. Examples of the fluoric polymer are polyvinylidene fluoride, polyvinylidene fluoride-polyhexafluoropropylene copolymers, polyvinylidene fluoride-polytetrafluoroethylene copolymers, and polyvinylidene fluoride-polytrifluoroethylene copolymers.

Although the nonaqueous electrolyte battery of the present invention is described as a secondary battery in the above embodiment, the nonaqueous electrolyte battery is also applicable to a primary battery. Although the coin-shaped nonaqueous electrolyte battery is described in the above embodiment, the shape and size of the nonaqueous electrolyte battery are not limited. The shape may be a cylinder, a prism, or a button and the size may be thin or large.

### EXAMPLES

Examples prepared to prove the effect of the present invention will be described below. Although the following results are described by using specific values, the present invention is not limited thereto.

Preparation of Samples

A mixture containing 10% by weight of copper, 70% by weight of silicone, 15% by weight of indium, and 5% by weight of antimony was melted by using a high frequency induction heater. The molten composition was ejected on a rotating copper roller to prepare a ribbon sample. The ribbon sample was pulverized and the powdered sample was named Sample A.

Samples B to G were prepared in the same manner as Sample A, except that the copper, silicon, indium, and antimony contents were adjusted as shown in Table 1.

TABLE 1

| | Copper | Silicon | Indium | Antimony |
|---|---|---|---|---|
| Sample | (weight %) | (weight %) | (weight %) | (weight %) |
| A | 10 | 70 | 15 | 5 |
| B | 30 | 50 | 15 | 5 |
| C | 40 | 40 | 15 | 5 |
| D | 50 | 30 | 15 | 5 |
| E | 70 | 10 | 15 | 5 |
| F | 75 | 5 | 15 | 5 |
| G | 80 | 0 | 15 | 5 |

Next, another composition containing 10% by weight of copper, 30% by weight of silicone, and 60% by weight of indium was mixed by using a ball mill for 20 hours to form an alloy named Sample H.

Samples I to N were prepared in the same manner as Sample H, except that the copper, silicon, and indium contents were adjusted as shown in Table 2.

TABLE 2

| | Copper | Silicon | Indium |
|---|---|---|---|
| Sample | (weight %) | (weight %) | (weight %) |
| H | 10 | 30 | 60 |
| I | 20 | 30 | 50 |
| J | 30 | 30 | 40 |
| K | 50 | 40 | 10 |
| L | 51 | 44 | 5 |
| M | 54 | 45 | 1 |
| N | 52 | 48 | 0 |

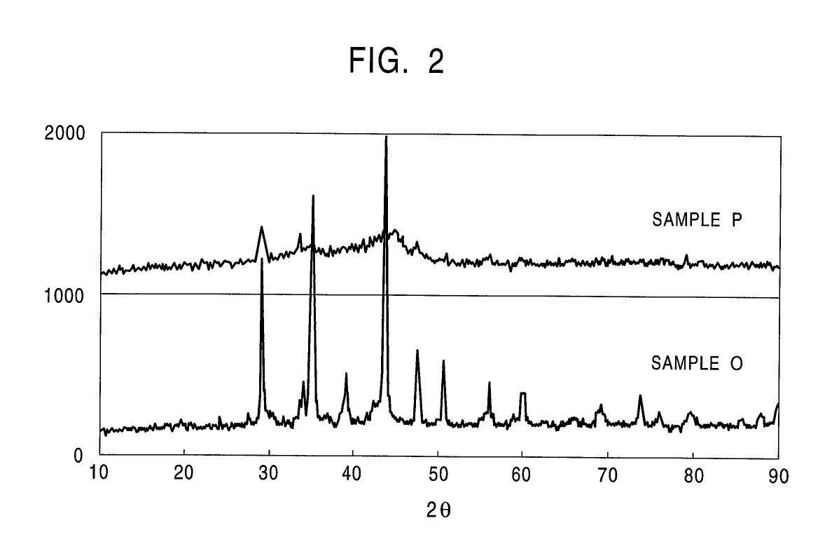

Another composition containing 65% by weight of copper, 15% by weight of silicon, and 20% by weight of indium was mixed for 5 hours to form an alloy named Sample O. The same composition was mixed for 40 hours and then was alloyed. The alloy was named Sample P. Samples 0 and P were analyzed by using an X-ray diffractometry to obtain a diffraction pattern shown in FIG. 2. The pattern showed that Sample P was amorphous.

Sample Q was prepared in the same manner as Sample P, except that half of the copper content was replaced with iron. That is, Sample Q contained 32.5% by weight of copper and 32.5% by weight of iron, which were the first elements.

Several nonaqueous electrolyte batteries were prepared with negative electrode active materials containing Samples A to Q, for evaluating battery performance.

### Example 1

Sample A was used as a negative electrode active material. Then, 80% by weight of the negative electrode active material, 10% by weight of artificial graphite as a conductor, 10% by weight of polyvinylidene fluoride as a binder, and dimethylformamide as a solvent were mixed and the mixture was dried to prepare a negative electrode mixture. A nickel mesh as a collector and 37 mg of the negative electrode mixture were formed into a pellet having a diameter of 15.5 mm. The pellet was used as a negative electrode.

Metallic lithium was stamped out to form a reference electrode having the substantially same shape as the above negative electrode. A nonaqueous electrolyte solution was prepared by dissolving LiPF₆ into an equivolume mixture of ethylcarbonate and dimethylcarbonate in a ratio of 1 mol/l.

The negative electrode was placed in the negative electrode case, the reference electrode was placed in a reference electrode case, and a separator of a porous polyethylene film was placed between the negative electrode and the reference electrode. The nonaqueous electrolyte solution was poured into the negative electrode case and the reference electrode case, both cases were caulked with an insulating gasket placed therebetween to form a coin-shaped nonaqueous electrolyte battery having a diameter of 20 mm and a thickness of 2.5 mm.

### Examples 2 to 7

Other coin-shaped nonaqueous electrolyte batteries were prepared in the same manner as in EXAMPLE 1 except that Samples B to G were used as the negative electrode active materials instead of Sample A.

The charge and discharge test described below was performed for the above coin-shaped batteries to evaluate the battery performance.

The purpose of the charge and discharge test was to evaluate the lithium-doping and undoping capabilities of the negative electrode active materials. In the test, the process in which a negative electrode active material was doped with lithium, that is, the process in which the voltage of the test cell decreased, was defined as “charge”. Also, the process in which the negative electrode active material was undoped with lithium, that is, the process in which the voltage of the test cell increased, was defined as “discharge”.

The test cell was charged up to a voltage of 0 V at a constant current of 1 mA. After the voltage of the test cell reached 0 V, the test cell was charged at a decreased current so that the voltage of 0 V was maintained. The charge of the test cell was completed when the current became less than 20 μA.

The test cell was discharged at a constant current of 1 mA, and the discharge of the test cell was completed when the voltage of the test cell exceeded 1.2 V. The discharge capacities per weight of the negative electrode active materials were calculated.

The cycle performance of the batteries was evaluated according to the retention rate (%) defined as follows: retention rate (%)=(discharge capacity at 50th cycle/discharge capacity at 1st cycle)×100.

Table 3 shows the evaluation of the batteries of EXAMPLES 1 to 7

TABLE 3

| | Negative | | |
|---|---|---|---|
| | electrode | Discharge | Retention |
| | active | capacity | rate |
| EXAMPLE | material | (mAh/g) | (%) |
| 1 | Sample A | 2,400 | 51 |
| 2 | Sample B | 1,700 | 76 |
| 3 | Sample C | 1,200 | 80 |
| 4 | Sample D | 900 | 90 |
| 5 | Sample E | 750 | 98 |
| 6 | Sample F | 700 | 94 |
| 7 | Sample G | 140 | 100 |

In view of the discharge capacity, EXAMPLE 7 was significantly inferior to EXAMPLES 1 to 6; hence, the silicon content must be 5% by weight or more, and preferably 10% by weight or more.

Next, in view of the retention rate, EXAMPLE 1 is significantly inferior to EXAMPLES 2 to 6; hence, the silicon content must be 50% by weight or less, and preferably 40% by weight or less.

The retention rates of EXAMPLES 4 to 6 are excellent; hence, the total content of silicon, indium, and antimony is preferably 50% by weight or less.

Although samples of the above EXAMPLES 1 to 7 contain silicon as the second element, samples containing tin instead of silicon exhibit substantially the same characteristics but slightly decreased discharge capacities.

### Example 8

A petroleum pitch, which was provided as the starting material of the carbon material, was crosslinked with oxygen by introducing 10 to 20 by weight of oxygen-containing functional groups to the petroleum pitch and was calcined at 1,000° C. in an inert gas stream to form a non-graphitizable carbon. The non-graphitizable carbon was analyzed by X-ray diffractometry, and the resulting pattern showed that the non-graphitizable carbon had an (002) interplane distance of 3.76 Å and a true specific gravity of 1.58 g/cm³.

The non-graphitizable carbon was pulverized to form carbon powder having an average particle diameter of 50 μm. A negative electrode active material containing 2 parts by weight of the carbon powder and 1 part by weight of Sample H was prepared. Then, 80% by weight of the negative electrode active material, 10% by weight of artificial graphite as a conductor, 10% by weight of polyvinylidene fluoride as a binder, and dimethylformamide as a solvent were mixed and the mixture was dried to prepare a negative electrode mixture. A nickel mesh as a collector and 37 mg of the negative electrode mixture were formed into a pellet having a diameter of 15.5 mm. The pellet was used as a negative electrode.

Metallic lithium was stamped out to form a reference electrode having the substantially same shape as the above negative electrode. A nonaqueous electrolyte solution was prepared by dissolving LiPF₆ into an equivolume mixture of ethylcarbonate and dimethylcarbonate in a ratio of 1 mol/l.

The negative electrode was placed in the negative electrode case, the reference electrode was placed in a reference electrode case, and a separator of a porous polyethylene film was placed between the negative electrode and the reference electrode. The nonaqueous electrolyte solution was poured into the negative electrode case and the reference electrode case, and both cases were caulked with a insulating gasket placed therebetween to form a coin-shaped nonaqueous electrolyte battery having a diameter of 20 mm and a thickness of 2.5 mm.

### Examples 9 TO 14

Other coin-shaped nonaqueous electrolyte batteries were prepared in the same manner as those of EXAMPLE 8 except that Samples I to N were used as the negative electrode active materials instead of Sample H.

The charge and discharge test described above was performed for the above coin-shaped batteries to evaluate the battery performance.

Table 4 shows the evaluation of the batteries of EXAMPLES 8 to 4.

TABLE 3

| | Negative | | |
|---|---|---|---|
| | electrode | Discharge | Retention |
| | active | capacity | rate |
| EXAMPLE | material | (mAh/g) | (%) |
| 8 | Sample H | 1,660 | 65 |
| 9 | Sample I | 1,620 | 74 |
| 10 | Sample J | 1,680 | 78 |
| 11 | Sample K | 1,650 | 78 |
| 12 | Sample L | 1,660 | 75 |
| 13 | Sample M | 1,620 | 68 |
| 14 | Sample N | 1,631 | 53 |

EXAMPLES 8 to 14 exhibit substantially the same discharge capacity, and EXAMPLES 8 to 13 exhibit the high retention rates in contrast to EXAMPLE 14; hence, the indium content must be 1% by weight or more and 50% by weight or less, and preferably 5% by weight or more and 40% by weight or less.

EXAMPLES 9 and 10 are excellent in the retention rate compared with EXAMPLE 8; hence, the total content of silicon and indium is preferably 80% by weight or less, and more preferably 70% by weight or less.

Although the sample of EXAMPLES 8 to 14 contained indium as the third element, samples containing antimony instead of indium as the third element exhibit substantially the same discharge capacity and retention rate. Also, EXAMPLES containing bismuth or lead instead of indium exhibit substantially the same discharge capacities but slightly decreased retention rates.

### Example 15

A petroleum pitch, which was provided as the starting material of the carbon material, was calcined at 1,000° C. in an inert gas stream to form a graphitizable carbon. The graphitizable carbon was pulverized to form carbon powder having an average particle diameter of 50 μm.

A negative electrode active material containing the same amount by weight of the carbon powder and Sample O was prepared. Then, 80% by weight of the negative electrode active material, 10% by weight of artificial graphite as a conductor, 10% by weight of polyvinylidene fluoride as a binder, and dimethylformamide as a solvent were mixed and the mixture was dried to a negative electrode mixture. A nickel mesh as a collector and 37 mg of the negative electrode mixture were formed into a pellet having a diameter of 15.5 mm, and the pellet was used as a negative electrode.

Metallic lithium was stamped out to form a reference electrode having the substantially same shape as the above negative electrode. A nonaqueous electrolyte solution was prepared by dissolving LiPF₆ into an equivolume mixture of ethylcarbonate and dimethylcarbonate in a ratio of 1 mol/l.

The negative electrode was placed in the negative electrode case, the reference electrode was placed in a reference electrode case, and a separator of a porous polyethylene film was placed between the negative electrode and the reference electrode. The nonaqueous electrolyte solution was poured into the negative electrode case and the positive electrode case, and both cases were caulked with a insulating gasket placed therebetween to form a coin-shaped nonaqueous electrolyte battery having a diameter of 20 mm and a thickness of 2.5 mm.

### Examples 16 to 17

Other coin-shaped nonaqueous electrolyte batteries were prepared in the same manner as in EXAMPLE 15 except that Samples P and Q were used as the negative electrode active material instead of Sample O.

The charge and discharge test described above was performed for the above coin-shaped batteries to evaluate the battery performance.

As a result, EXAMPLES 15 and 16 have substantially the same discharge capacity and retention rate, and EXAMPLE 15 has a plateau in the vicinity of 0.5 V in the discharge curve thereof. On the other hand, EXAMPLE 16 has a gentle declivity and there are no plateaus in the discharge curve thereof. Thus, the composition is preferably amorphous.

EXAMPLE 17 has a discharge capacity which is 4% less than that of EXAMPLE 16 and has substantially the same retention rate as that of EXAMPLE 16.

Next, a cylindrical battery was prepared as follows for evaluation.

### Example 18

A negative electrode was prepared as follows. Artificial graphite having an average particle diameter of 20 μm was prepared as a carbon material. Then, 43% by weight of the powdered carbon material, 42% by weight of Sample E, 10% by weight of artificial graphite as a conductive agent, and 5% by weight of polyvinylidene fluoride (PDVF) as a binder were mixed to prepare a negative electrode mixture. The negative electrode mixture was dispersed into N-methyl-2-pyrrolidone to form slurry. The slurry was applied onto both sides of a copper foil strip which was a negative electrode collector and had a thickness of 15 μm. After drying, the copper foil strip was pressed into a negative electrode with a roll press machine.

A positive electrode was prepared as follows: in order to form the positive electrode of LiCoO₂, 0.5 parts by mole of lithium carbonate and 1 part by mole of cobalt carbonate were mixed and the mixture was fired at 900° C. for 5 hours in air; then 91 parts by weight of the resulting LiCoO₂, 6 parts by weight of graphite as a conductor, and 3 parts by weight of polyvinylidene fluoride (PDVF) as a binder were mixed to form a positive electrode mixture; the positive electrode mixture was dispersed into N-methyl-2-pyrrolidone to form slurry; the slurry was applied onto both sides of an aluminum foil strip which was a positive electrode collector and had a thickness of 20 μm; and after drying, the resulting aluminum foil strip was pressed into a positive electrode with a roll press machine.

The positive electrode, a separator composed of a porous polypropylene film having a thickness of 25 μm, and the negative electrode were stacked in that order and the stack was wound a plurality of turns in a vortex shape to form a roll.

An insulator was placed at the bottom of a battery case made of iron plated with nickel and then the roll was placed in the battery case. In order to collect a current in the negative electrode, one end of a nickel lead was connected to the negative electrode by contact bonding and the other end of the nickel lead was connected to the battery case by welding. In order to collect a current in the positive electrode, one end of an aluminum lead was connected to the positive electrode and the other end of the aluminum lead was connected to a battery cap through a insulating sheet for blocking a current in the battery.

The battery case was filled with a nonaqueous electrolyte solution which was prepared by dissolving LiPF₃ in a ratio of 1.0 mol/l into a mixed solvent consisting of 50% by volume of ethylene carbonate and 50% by volume of diethyl carbonate. The battery cap was fixed by caulking the battery case with an insulating sealing gasket, onto which asphalt was applied, and placed between the battery cap and the battery case to prepare a cylindrical nonaqueous electrolyte battery having a diameter of 18 mm and a height of 65 mm.

The battery of EXAMPLE 18 had a discharge capacity, which was increased by 13%, and had the same level of the retention rate compared with conventional batteries not containing Sample E.

What is claimed is:

1. A negative electrode active material comprising:
a composition A-B-C containing a first element A, a second element B, and a third element C,
wherein the first element A is at least one selected from copper and iron; the second element B is at least one selected from silicon and tin; and the third element C is at least one selected from the group consisting of indium, antimony, bismuth, and lead.

2. A negative electrode active material according to claim 1, wherein the first element A is copper, the second element B is silicon, and the third element C is at least one selected from indium and antimony.

3. A negative electrode active material according to claim 1, wherein the composition A-B-C contains 5 to 50% by weight of the second element B and contains 1 to 50% by weight of the third element C.

4. A negative electrode active material according to claim 1, wherein the composition A-B-C has low crystallinity.

5. A negative electrode active material according to claim 1, wherein the composition A-B-C is amorphous.

6. A nonaqueous electrolyte battery comprising:
a positive electrode containing a positive electrode active material;
a negative electrode containing a negative electrode active material; and
a nonaqueous electrolyte,
wherein the negative electrode active material contains a composition A-B-C containing a first element A, a second element B, and a third element C, in which the first element A is at least one selected from copper and iron, the second element B is at least one selected from silicon and tin, and the third element C is at least one selected from the group consisting of indium, antimony, bismuth, and lead.

7. A nonaqueous electrolyte battery according to claim 6, wherein the first element A is copper, the second element B is silicon, and the third element C is at least one selected from indium and antimony.

8. A nonaqueous electrolyte battery according to claim 6, wherein the composition A-B-C contains 5 to 50% by weight of the second element B and contains 1 to 50% by weight of the third element C.

9. A nonaqueous electrolyte battery according to claim 6, wherein the composition A-B-C has low crystallinity.

10. A nonaqueous electrolyte battery according to claim 6, wherein the composition A-B-C is amorphous.

11. A nonaqueous electrolyte battery according to claim 6, wherein the negative electrode further contains a carbonaceous material which is capable of being doped and being undoped with lithium.

12. A nonaqueous electrolyte battery according to claim 11, wherein the carbonaceous material is one selected from the group consisting of non-graphitizable carbon, graphitizable carbon, and graphite.
